(19) United States
(12) Patent Application Publication
(10) Pub. No.: US 2016/0315426 A1
(43) Pub. Date: Oct. 27, 2016

(54) CONNECTOR AND ELECTRONIC DEVICE

(71) Applicant: Kyocera Corporation, Kyoto (JP)

(72) Inventors: Yasuhiro UENO, Yokohama-shi (JP); Masayoshi NAKAJIMA, Tokyo (JP)

(73) Assignee: Kyocera Corporation, Kyoto (JP)

(21) Appl. No.: 15/131,346

(22) Filed: Apr. 18, 2016

(30) Foreign Application Priority Data
Apr. 23, 2015 (JP) 2015-088622
Apr. 23, 2015 (JP) 2015-088624

(51) Int. Cl. H01R 13/66; H01R 13/52; H02J 7/00; H01R 24/58

(52) U.S. Cl. CPC H01R 13/6675; H01R 24/58; H01R 13/52; H02J 7/0045; H02J 7/0052; H01R 2107/00

(57) ABSTRACT

A connector includes a connecting portion, which connects electrically to another apparatus, and a power storage unit. At least a portion of the power storage unit is disposed inside the connecting portion.

### CROSS-REFERENCE TO RELATED APPLICATION

This application claims priority to and the benefit of Japanese Patent Application No. 2015-088622 filed Apr. 23, 2015, and Japanese Patent Application No. 2015-088624 filed Apr. 23, 2015, the entire contents of which are incorporated herein by reference.

### BACKGROUND

In recent years, along with increased performance and heightened multi-functionality of mobile information terminals, modules that are connected to a mobile information terminal to add new functionality are being developed. For example, JP 2014-14423 A (PTL 1) discloses a skin property measurement device that can easily be connected to a variety of mobile terminals and a mobile terminal to which the skin property measurement device is connected.

JP 2008-33467 A (PTL 2) discloses a wrist-worn electronic pedometer that has a minimized planar size while having an internal battery.

### CITATION LIST

### Patent Literature

PTL 1: JP 2014-14423 A

PTL 2: JP 2008-33467 A

### SUMMARY

A connector of this disclosure includes: a connecting portion configured to connect electrically to another apparatus; and a power storage unit, such that at least a portion of the power storage unit is disposed inside the connecting portion.

An electronic device of this disclosure includes: a functional unit; a power storage unit configured to supply power to the functional unit; and a connector including a connecting portion, the connector configured to connect electrically to another apparatus via the connecting portion, such that at least a portion of the power storage unit is disposed inside the connector.

### BRIEF DESCRIPTION OF THE DRAWINGS

In the accompanying drawings:

FIG. 1 illustrates the structure of an electronic device according to Embodiment 1;

FIGS. 2A and 2B illustrate the structure of a connecting portion in an electronic device according to Embodiment 1;

FIG. 3 illustrates the structure of a power storage unit provided in the electronic device according to Embodiment 1;

FIG. 4 is a block diagram illustrating signal processing at the time of charging in the electronic device according to Embodiment 1;

FIG. 5 illustrates the paths over which data, charging power, and supply power flow in the electronic device according to Embodiment 1;

FIGS. 6A and 6B are external views of the electronic device according to Embodiment 1;

FIG. 7 illustrates signal processing at the time of data transmission and reception in the electronic device according to Embodiment 1;

FIG. 8 is a flowchart illustrating an example of control at the time of charging the power storage unit and at the time of data transmission in the electronic device according to Embodiment 1;

FIGS. 9A and 9B illustrate the structure of a power storage unit and a connecting portion provided in an electronic device according to Embodiment 2;

FIGS. 10A and 10B illustrate the structure of a power storage unit and a connecting portion provided in an electronic device according to Embodiment 3; and

FIGS. 11A and 11B illustrates the structure of an electronic device according to Embodiment 4.

### DETAILED DESCRIPTION

According to the connector and electronic device of this disclosure, the increase in overall volume can be reduced even when including an internal power storage unit. The following describes various embodiments in detail with reference to the drawings.

### Embodiment 1

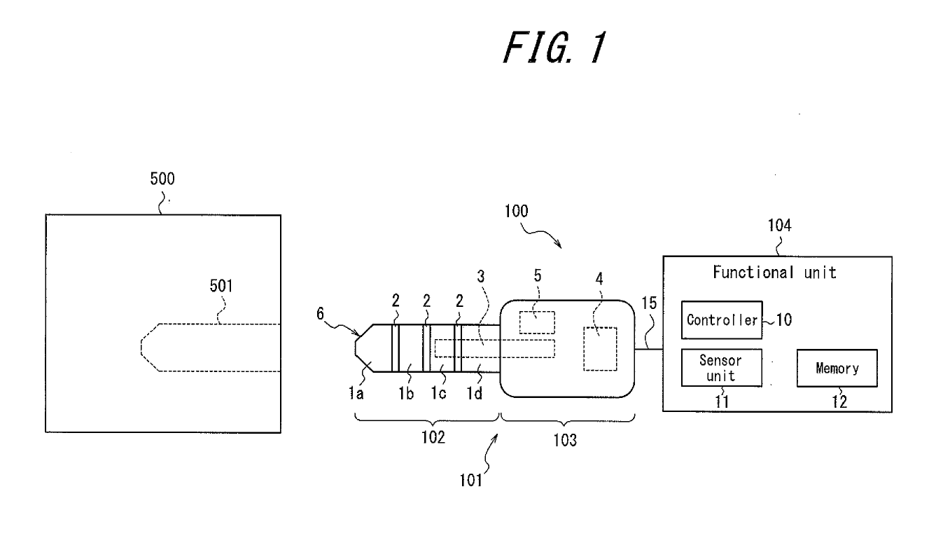

FIG. 1 illustrates the structure of an electronic device 100 according to Embodiment 1. The electronic device 100 of this embodiment includes a connector 101 for electrically connecting to another apparatus 500 and a functional unit 104 that controls the main functions of the electronic device 100, in which a sensor or the like is mounted.

First, the structure of the connector 101 is described.

The connector 101 includes a connecting portion 102 for electrical connection by insertion into an earphone jack 501 provided in the other apparatus 500 and a holding portion 103 for the user to hold the connector 101 when inserting the connecting portion 102 in the earphone jack 501.

The connecting portion 102 may for example be a φ3.5 mm four-pole miniature single-head plug conforming to the RC5325A standard of the Japan Electronics and Information Technology Industries Association (JEITA). In this embodiment, the conductive portions 1a to 1d disposed to be electrically insulated from each other by insulators 2 in FIG. 1 may be allocated as a left audio signal (L signal) terminal, a right audio signal (R signal) terminal, a GND terminal, and a microphone signal terminal. In accordance with the specifications of the other apparatus 500, the conductive portions 1c and 1d may instead be allocated as a microphone signal terminal and a GND terminal. In this disclosure, the portion including the conductive portions 1a to 1d that forms the outer shape of the connecting portion 102 may be defined as a housing 6.

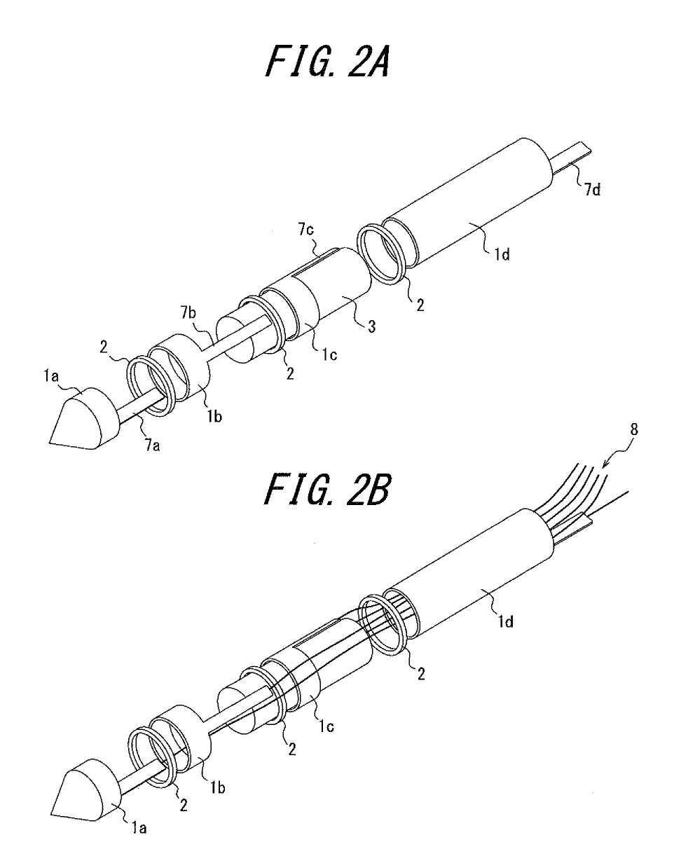

FIG. 2A illustrates the structure of the connecting portion 102 in greater detail. FIG. 2A is an exploded perspective view of the connecting portion 102 in FIG. 1 in the central axis direction. The conductive portions 1a to 1d include terminals 7a to 7d extending in the central axis direction. As illustrated in FIG. 2B, the terminals 7a to 7d are connected to connecting portion wiring 8 for conducting signals from the conductive portions 1a to 1d independently to the holding portion 103 and the functional unit 104. In FIG. 2A, the power storage unit 3 is depicted as being of a size that can be accommodated inside the connecting portion 102, but a structure may be adopted in which only a portion of the power storage unit 3 is disposed inside the connecting portion 102, as in FIG. 1.

Brass, for example, may be used as the material of the conductive portions 1a to 1d, and the brass may be plated with gold, nickel, or the like. Polyacetal resin, for example, may be used as the material of the insulators 2.

In accordance with the specifications of the other apparatus 500, the connecting portion 102 of this embodiment may, for example, be replaced with a so-called φ6.3 mm phone plug conforming to the EIA-453 standard of the Electronics Industries Alliance (EIA) or a variety of other connectors conforming to IEEE-1394 or the like.

The holding portion 103 includes a charging controller 4 that controls charging of the power storage unit 3 and a circuit 5 that performs functions such as power conversion of the audio signal supplied from the other apparatus 500 via the conductive portions 1a and 1b. A portion of the power storage unit 3 is disposed inside the connecting portion 102, and the other portion is disposed inside the holding portion 103. The configuration of the power storage unit 3 is not limited to the one in this embodiment. It suffices for a portion of the power storage unit 3 to be disposed somewhere inside the connector 101, such as within the holding portion 103 or the like.

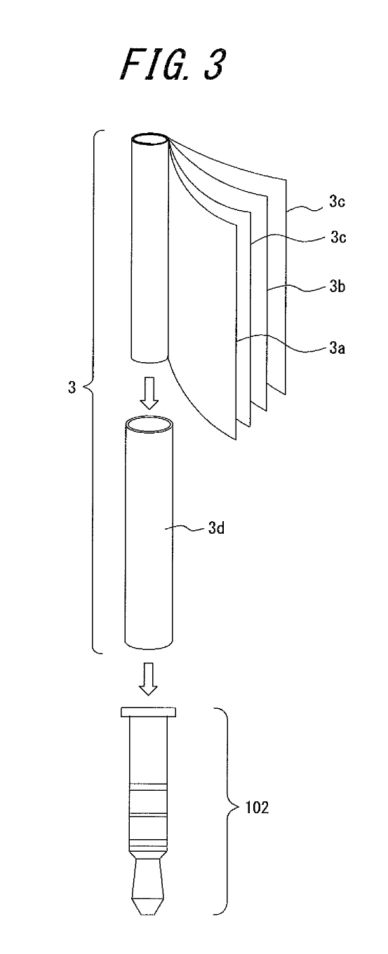

The power storage unit 3 charges with electrical power supplied by the other apparatus 500. As the power storage unit 3, for example a lithium-ion battery that includes a positive electrode 3a, a negative electrode 3b, and separators 3c inserted into a metal tubular case 3d, as illustrated in FIG. 3, may be used. The power storage unit 3 is not, however, limited to this example. The power storage unit 3 may, for example, be configured with a different secondary battery such as a nickel-metal hydride battery, a nickel-cadmium battery, or the like. The power storage unit 3 may also be configured with a primary battery such as a manganese battery or the like, or with a capacitor.

The charging controller 4 monitors the state of connection with the other apparatus 500, the amount of charge of the power storage unit 3, and the like, and based on the results, controls charging from the other apparatus 500 to the power storage unit 3. The charging controller 4 may, for example, be implemented by a microcomputer. The functions of the charging controller 4 may be configured to be implemented by the below-described controller 10, provided in the functional unit 104, or the like. Alternatively, the charging controller 4 may be provided in the other apparatus 500.

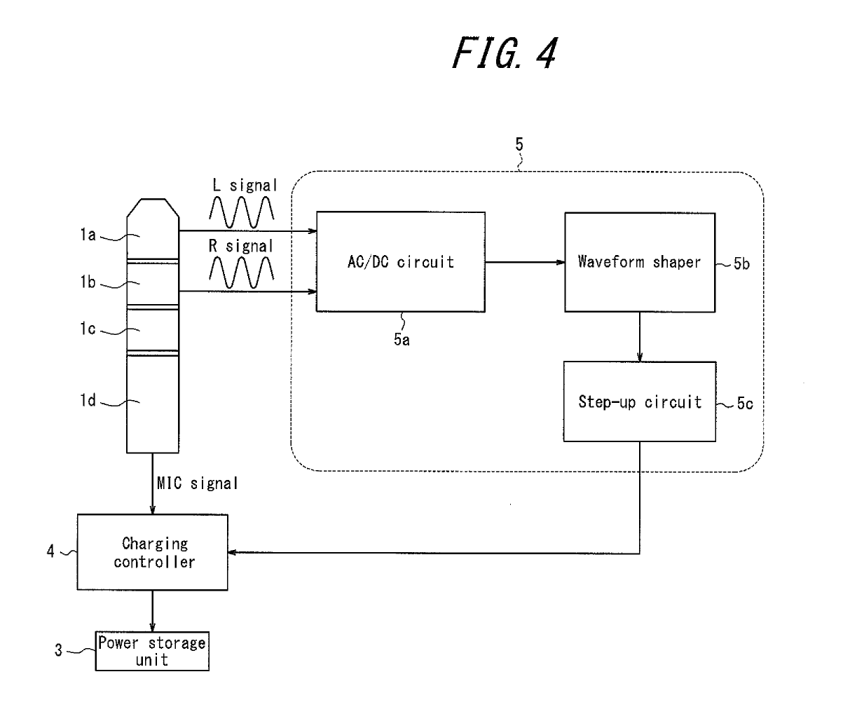

The circuit 5 converts an audio signal, which is AC power supplied from the other apparatus 500 via the conductive portions 1a and 1b, to DC power with an AC/DC circuit 5a and a waveform shaper 5b illustrated in FIG. 4 and then boosts the voltage to a predetermined voltage with a step-up circuit 5c illustrated in FIG. 4. The power storage unit 3 is charged by the charging controller 4 with the power for which the voltage was boosted. The power storage unit 3 is also charged by the charging controller 4 with DC power for the microphone power supply that is supplied from the other apparatus 500 via the conductive portion 1d without this power being converted. A configuration may also be adopted so that the DC power for the microphone power supply is also supplied to the power storage unit 3 after being boosted by the step-up circuit 5c.

Next, the structure of the functional unit 104 is described.

The functional unit 104 includes a functional element for implementing the main functions of the electronic device 100. In this embodiment, the functional unit 104 includes the following: a sensor unit 11 having a sensor 11b as the functional element, the controller 10 to perform various controls for implementing the corresponding functions, and a memory 12 for storing data from the sensor unit 11 and the like. The connector 101 and the functional unit 104 may be disposed adjacent to one another or may be disposed at a distance from each other by being connected electrically by wiring 15 in FIG. 1.

The connector 101 and the functional unit 104 need not be clearly separated. For example, the connector 101 may be configured to include the functional unit 104.

The following describes the flow of signals at the time of charging of the power storage unit 3, supplying power to the functional unit 104, and transmitting data.

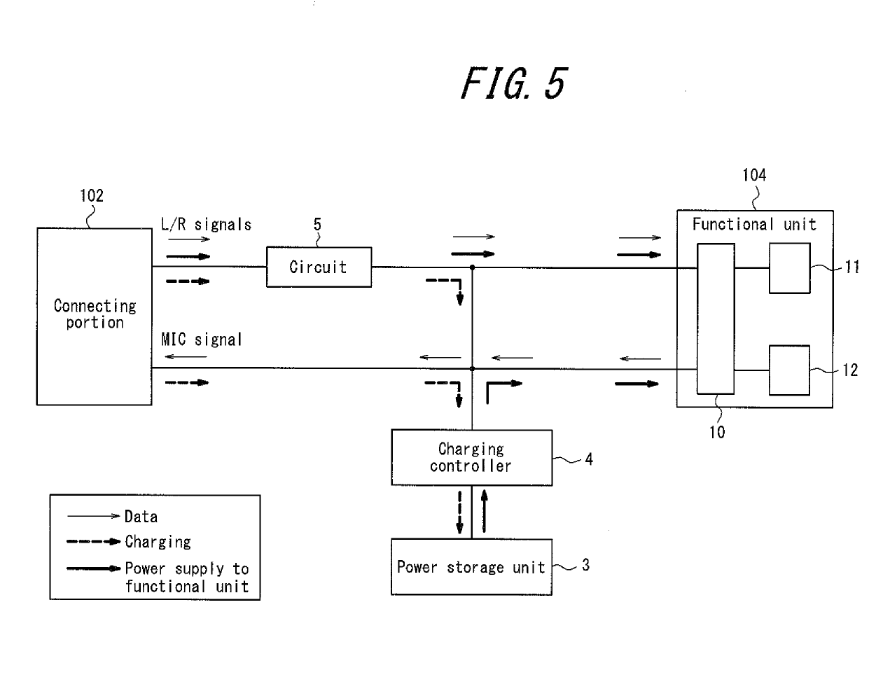

In FIG. 5, the power for supply to the functional unit 104 is indicated by thick solid lines. When the connector 101 is connected to the other apparatus 500 via the connecting portion 102, the L signal and R signal from the other apparatus 500 are converted to a predetermined DC power in the circuit 5 and supplied to the functional unit 104. On the other hand, when the connector 101 is not connected to the other apparatus 500, the charging controller 4 discharges the power charged in the power storage unit 3 and supplies the discharged power to the functional unit 104. A configuration may be adopted such that if the amount of charge of the power storage unit 3 is sufficiently large, power is supplied to the functional unit 104 from the power storage unit 3 even when the connector 101 is connected to the other apparatus 500. A configuration may also be adopted such that when the connector 101 is connected to the other apparatus 500, the power of the microphone signal is supplied to the functional unit 104 in addition to, or instead of, the power of the L signal and the R signal.

In FIG. 5, the power for charging the power storage unit 3 is indicated by thick dashed lines. When the electronic device 100 is connected to the other apparatus 500 via the connecting portion 102, the L signal and R signal from the other apparatus 500 are converted to a predetermined DC power in the circuit 5 and used to charge the power storage unit 3. The DC power from the other apparatus 500 for supplying the microphone is used to charge the power storage unit 3 without being converted.

In FIG. 5, the data received from the other apparatus 500 and the data transmitted to the other apparatus 500 are indicated by thin solid lines. When data is stored in the memory 12, the functional unit 104 transmits the data as a microphone signal via the conductive portion 1d in the connecting portion 102. The functional unit 104 receives data from the other apparatus 500 as an L signal and an R signal via the conductive portions 1a and 1b in the connecting portion 102. When data is being received from the other apparatus 500, the controller 10 performs control so that the circuit 5 does not convert the L signal and R signal to DC power. At this time, the data received from the other apparatus 500 is transmitted to the functional unit 104 without undergoing power conversion.

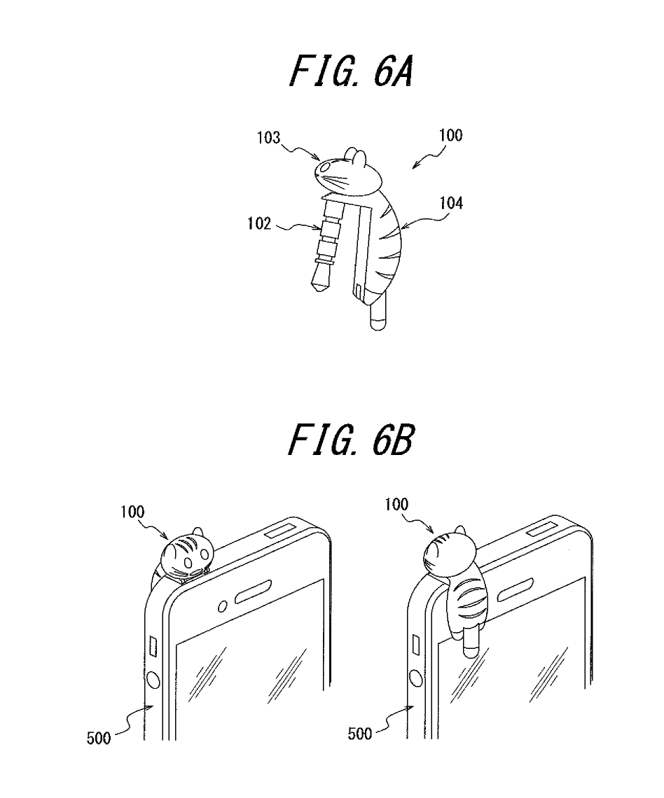

FIG. 6A is an external view of the electronic device 100 according to this embodiment. The holding portion 103 of the connector 101 is disposed adjacent to the base of the connecting portion 102 and is formed to have the shape of an animal head. The functional unit 104 that is further provided adjacent to the holding portion 103 is disposed so as to turn back in the direction of the tip of the connecting portion 102. The functional unit 104 is formed so as to have the shape of an animal torso. FIG. 6B illustrates the state in which the connecting portion 102 of the electronic device 100 is inserted into the earphone jack 501 of the other apparatus 500. In the state in which the electronic device 100 is attached to the other apparatus 500, the functional unit 104 is disposed so as to be parallel to the display of the other apparatus 500. Accordingly, even when the electronic device 100 is connected to the other apparatus 500, no portion projects markedly. Hence, the portability of the other apparatus 500 is not easily affected.

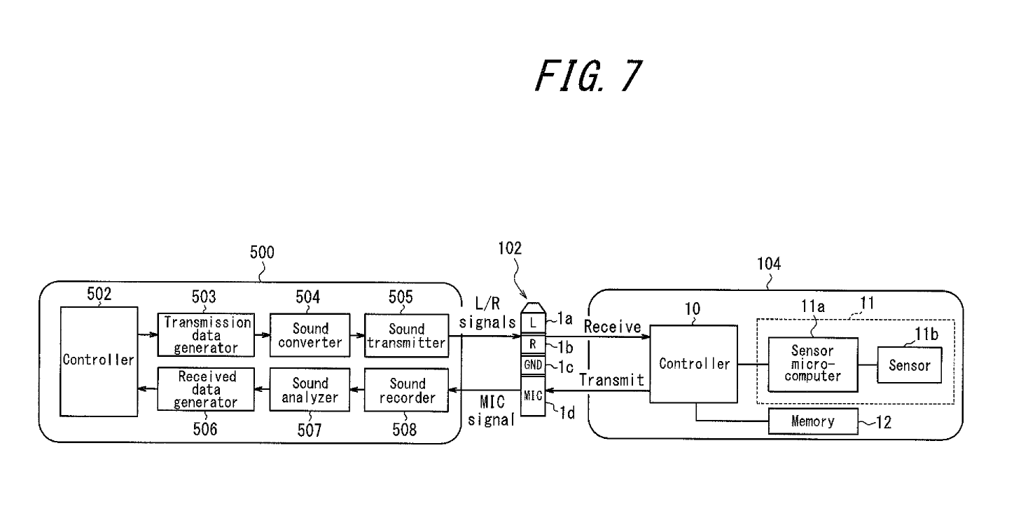

The flow of data when the electronic device 100 of this embodiment is connected to the other apparatus 500 is illustrated in FIG. 7 as a block diagram. Via the conductive portions 1a and 1b of the connecting portion 102, the controller 10 of the functional unit 104 receives a data signal output from the other apparatus 500 in the format of a left audio signal (L signal) and right audio signal (R signal). The data received by the controller 10 is, for example, a command to start operation of the sensor 11b, a command to read data from the memory 12, or the like. Upon receiving the command to start operation of the sensor 11b from the other apparatus 500, the controller 10 transmits a command to start measurement by the sensor 11b to a sensor microcomputer 11a included in the sensor unit 11. When data exists in the memory 12, the controller 10 transmits the data via the conductive portion 1d of the connecting portion 102 in the format of a microphone (MIC) signal.

The sensor 11b included in the sensor unit 11 may, for example, be an acceleration sensor, a gyro sensor, or an atmospheric pressure sensor. Mounting these sensors for example allows implementation of the functions of a walking state detector, a running state detector, a bicycle riding state detector, a vehicle state detector, a sleep state detector, an atmospheric pressure state detector, or the like. Alternatively, the sensor 11b included in the sensor unit 11 may be an ultraviolet light amount sensor, an illuminance sensor, a temperature sensor, a humidity sensor, a distance measurement sensor, or a sugar content sensor. Furthermore, the sensor 11b included in the sensor unit 11 may be a vital sign sensor such as a pulse sensor, a blood flow sensor, a blood pressure sensor, or the like.

On the other hand, when the other apparatus 500 transmits data to the electronic device 100, first a transmission data generator 503 generates transmission data by performing processing such as modulating the data from a controller 502 by a predetermined modulation scheme and adding an error correcting code. Next, a sound converter 504 converts the transmission data, which is a digital signal, to an audio signal (L signal and R signal), which is an analog signal. Finally, a sound transmitter 505 performs amplification of the audio signal, matching of the output impedance, and the like and outputs the result to the electronic device 100. The output audio signal is transmitted to the functional unit 104 via the conductive portions 1a and 1b included in the connecting portion 102 of the electronic device 100. When the other apparatus 500 receives data from the electronic device 100, the transmission data from the functional unit 104 of the electronic device 100 is input into a sound recorder 508 of the other apparatus 500 via the conductive portion 1d in the format of a microphone signal, which is an analog signal. The sound recorder 508 performs buffering and the like on the received signal and transmits the result to a sound analyzer 507. The sound analyzer 507 performs A/D conversion and the like on the microphone signal, which is an analog signal, and transmits the converted signal to a received data generator 506. The received data generator 506 decodes the output from the sound analyzer 507 by performing error correction, demodulation, and the like to generate received data. The decoded received data is used by the controller 502 for operation of a predetermined application.

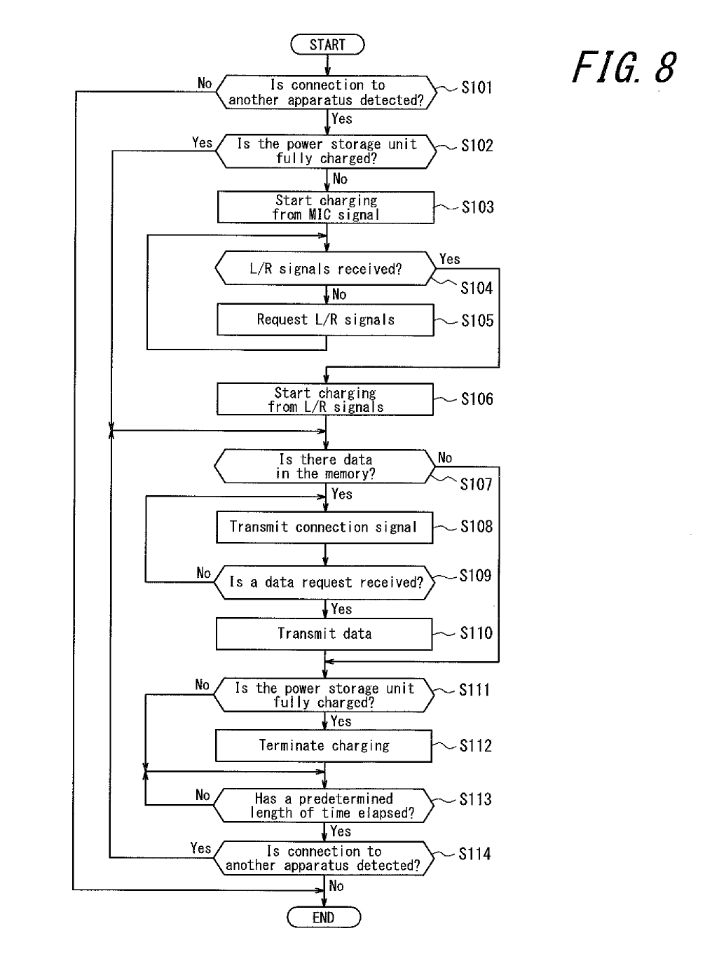

Next, an example of control at the time of charging and of data transmission and reception in the electronic device 100 of this embodiment is illustrated by the flowchart in FIG. 8.

The controller 10 of the electronic device 100 determines whether the connector 101 is connected to the other apparatus 500 (step S101). This determination of connection may be made based on notification from the other apparatus 500 of the fact that two members provided at the insertion opening for the earphone jack 501 of the other apparatus 500 have short-circuited due to insertion of the connector 101. When determining in step S101 that the connector 101 is connected to the other apparatus 500, the controller 10 causes the charging controller 4 to begin charging control of the power storage unit 3. On the other hand, when the controller 10 determines that the connector 101 is not connected to the other apparatus 500, charging of the power storage unit 3 and the transmission and reception of data cannot be performed. Therefore, the controller 10 terminates the processing.

Upon detection of connection to the other apparatus 500, the charging controller 4 determines whether the power storage unit 3 is in a fully charged state (step S102). The determination of the fully charged state in step S102 depends on the type of the power storage unit 3. For example, in the case of a lithium-ion battery, the determination of a full charge may be made by managing the charging voltage and the charging current.

When determining in step S102 that the power storage unit 3 is not fully charged, the charging controller 4 first begins charging using the microphone (MIC) signal (step S103). Upon inserting the connector 101 into the four-pole earphone jack 501 that includes a microphone terminal supporting so-called plug-in power, a predetermined voltage for supplying power to a microphone is supplied to the conductive portion 1d that corresponds to the microphone terminal of the connecting portion 102. The power storage unit 3 is charged by supplying this predetermined voltage to the power storage unit 3. The charging controller 4 monitors the voltage applied to the conductive portion 1d. The charging controller 4 only begins charging of the power storage unit 3 when observing the predetermined voltage on the microphone terminal.

Conversely, in step S102, when determining that the power storage unit 3 is in a fully charged state, the controller 10 executes steps related to data transmission (step S107 onwards) without executing steps S103 to S106, which relate to charging.

After executing step S103, the controller 10 determines whether the conductive portions 1a and 1b of the connecting portion 102 are receiving an audio signal (L signal and R signal) (step S104). When determining that an audio signal is not being received, the controller 10 requests that the other apparatus 500 output an audio signal (step S105). This request for an audio signal may, for example, be made by the controller 10 transmitting a command to request output of an audio signal to the other apparatus 500 as a microphone signal via the conductive portion 1d. Upon entering a state of receiving an audio signal (step S104: Yes), the charging controller 4 begins charging the power storage unit 3 from the audio signal (step S106). Since the audio signal is an analog AC signal, the audio signal can be subjected to power conversion to a predetermined DC voltage suitable for charging by performing AC/DC conversion, waveform shaping, and voltage boosting, as described above.

Next, the controller 10 determines whether there is data that has not yet been transmitted in the memory 12 (step S107). In this embodiment, the data within the memory 12 is for example the result of measurement by the sensor 11b. Upon determining that data remains in the memory 12, the controller 10 transmits a connection signal to the other apparatus 500 via the conductive portion 1d (step S108). The connection signal is a signal requesting connection with the other apparatus 500 in order to transmit data stored on the electronic device 100. Conversely, upon determining that no data remains in the memory 12, the controller 10 executes step S111 without executing the steps related to data transmission (steps S108 to S110).

When the other apparatus 500 is operating normally, then upon receiving the connection signal transmitted by the electronic device 100 in step S108, the controller 502 of the other apparatus 500 transmits a data request signal to the electronic device 100. After executing step S108, the controller 10 of the electronic device 100 determines whether the data request signal has been received (step S109). Upon determining that the data request signal has been received, the controller 10 transmits the data in the memory 12 to the other apparatus 500 (step S110). Conversely, upon the determining that the data request signal has not been received, the controller 10 transmits the connection signal again (returns to step S108) and waits until receiving the data request signal.

Upon completing transmission of data in the memory 12, the controller 10 determines whether the power storage unit 3 is in a fully charged state (step S111). Upon determining that the power storage unit 3 is in a fully charged state, the controller 10 terminates the charging operation (step S112). Next, the controller 10 waits until a predetermined length of time elapses from execution of step S107 (step S113). In other words, the controller 10 determines whether there is data in the memory 12 at predetermined intervals of time and transmits the data to the other apparatus 500 when such data exists.

Upon determining in step S113 that a predetermined length of time has elapsed, the controller 10 determines whether the connector 101 of the electronic device 100 is connected to the other apparatus 500 (step S114). The determination in step S114 may be made with the same method as the determination in step S101. Upon determining that the connector 101 is still connected to the other apparatus 500, the controller 10 returns to step S107 and determines whether there is data in the memory 12. Conversely, when determining in step S114 that the connector 101 is not connected to the other apparatus 500, the controller 10 terminates the processing.

Even if the electronic device 100 becomes disconnected from the other apparatus 500, the controller 10 does not immediately suspend operation of the electronic device 100, but rather for example continues measurement by the sensor 11b for 10 to 12 hours and stores the measurement results in the memory 12. At the same time, the controller 10 also monitors the amount of charge of the power storage unit 3 via the charging controller 4, and when the amount of charge falls below a predetermined level, the controller 10 suspends operation of the functional unit 104 and places the electronic device 100 in standby mode. By performing such control, even when not receiving power from the other apparatus 500, the electronic device 100 can cause the functional unit 104 to operate by discharging the internal power storage unit 3. As a result, the electronic device 100 can cause the functional unit 104 to operate with a minimal amount of power.

As described above, according to this embodiment, the electronic device 100 includes the functional unit 104, the power storage unit 3, and the connector 101, and at least a portion of the power storage unit 3 is disposed inside the connector 101. Therefore, since the power storage unit 3 is disposed inside the connector 101, which until now has not been used as a location for disposing the power storage unit 3, the increase in overall volume of the electronic device 100 can be reduced even when including the power storage unit 3.

Furthermore, according to this embodiment, the power storage unit 3 is in particular disposed inside the connecting portion 102. As a result, the increase in volume of the electronic device 100 due to inclusion of the power storage unit 3 can be reduced.

According to this embodiment, the power storage unit 3 is charged with power supplied from the other apparatus 500 via the connecting portion 102. Therefore, the power storage unit 3 can be charged by simply inserting the connecting portion 102 of the electronic device 100 in the jack of the other apparatus 500.

According to this embodiment, charging of the power storage unit 3 from the other apparatus 500 is configured so that the charging controller 4 begins charging when electrical connection between the connector 101 and the other apparatus 500 is detected. As a result, charging can be started at an appropriate time.

According to this embodiment, when the connector 101 and the other apparatus 500 are electrically connected, power is supplied from at least one of the other apparatus 500 and the power storage unit 3, and when the connector 101 is electrically disconnected from the other apparatus 500, power is supplied from the power storage unit 3. As a result, the electronic device 100 can be caused to operate independently, without depending on the other apparatus 500. Hence, the user does not need to operate the other apparatus 500 continuously. The power necessary for operating the functional unit 104 can thus be reduced.

According to this embodiment, the functional unit 104 includes the sensor unit 11 and the memory 12, the memory 12 stores sensor information detected by the sensor unit 11, and when the connector 101 is connected to the other apparatus 500, the sensor information is transmitted to the other apparatus 500 via the connecting portion 102. As a result, without depending on the other apparatus 500, the electronic device 100 can independently cause the sensor 11b therein to operate, store the measurement results, and transmit the measurement results regularly to the other apparatus 500. Therefore, the user does not need to operate the other apparatus 500 continuously. The power necessary for operating the functional unit 104 can thus be reduced.

### Embodiment 2

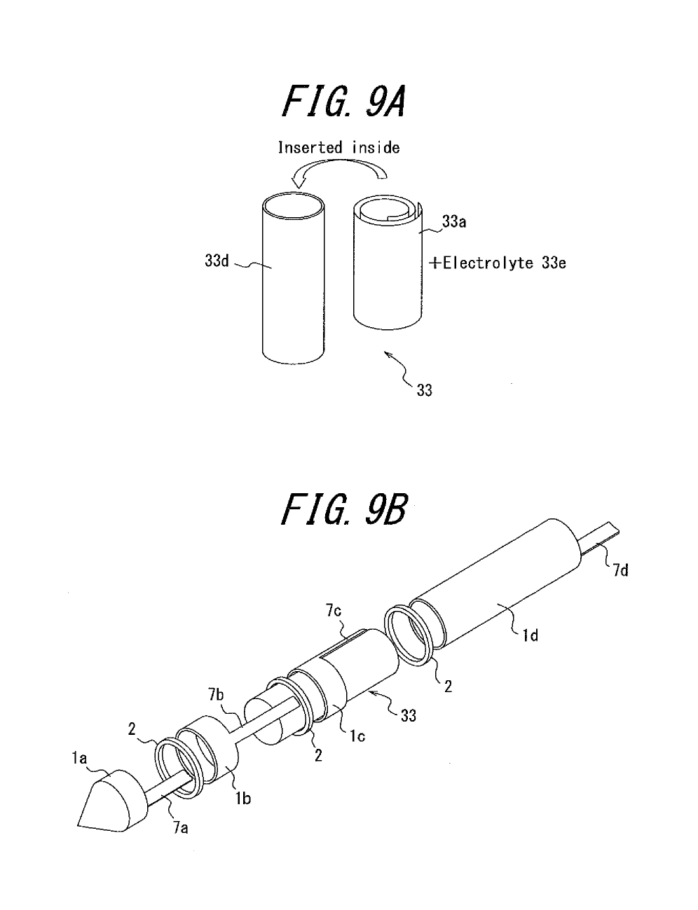

FIGS. 9A and 9B illustrate the structure of a power storage unit 33, and a connecting portion 102 housing the power storage unit 33, included in an electronic device according to Embodiment 2. Other than a different structure for the power storage unit 33, this embodiment has the same structure as that of Embodiment 1. Accordingly, the following explanation focuses on the structure of the power storage unit 33.

FIG. 9A illustrates the structure of the power storage unit 33 included in the electronic device of this embodiment. The power storage unit 33 includes a cylindrically shaped insulating layer 33d, into which are inserted a wound laminated film 33a and an electrolyte 33e. A positive electrode, negative electrode, and separator are overlapped in the laminated film 33a. The insulating layer 33d electrically insulates the laminated film 33a and electrolyte 33e from the conductive portions 1a to 1d. Polypropylene or the like, for example, may be used as the material for the insulating layer 33d. The power storage unit 33 in which the laminated film 33a and the electrolyte 33e are enclosed within the insulating layer 33d can be protected from shock or the like for example by being housed inside the conductive portions 1a to 1d of FIG. 9B.

As described above, in the power storage unit 33 according to this embodiment, the laminated film 33a in which the positive electrode, negative electrode, and separator are overlapped is inserted inside the insulating layer 33d along with the electrolyte 33e. The power storage unit 33 is then disposed inside the connecting portion 102. As a result, the power storage unit 33 can be protected from shock or the like without using a highly rigid, tubular case as the container for the power storage unit 33, as in Embodiment 1. Therefore, the number of components can be reduced.

### Embodiment 3

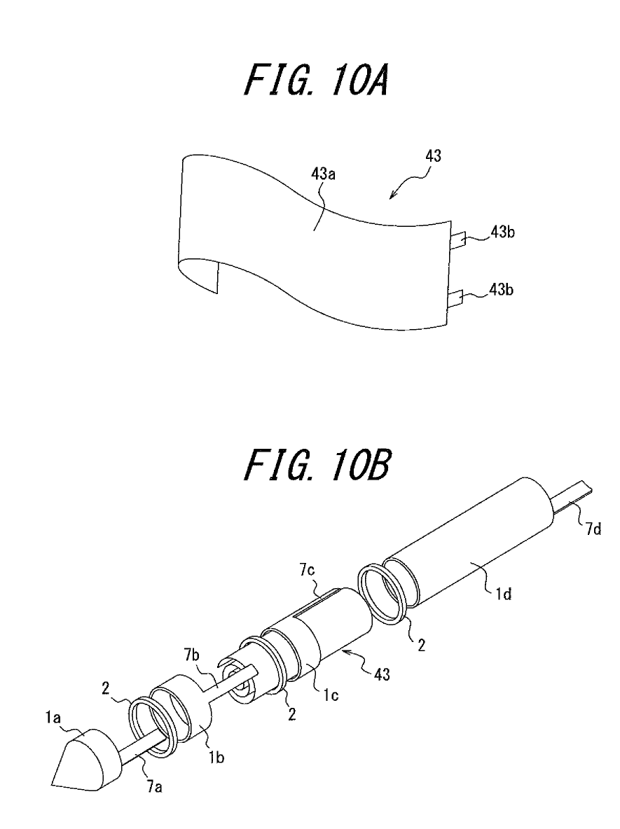

FIGS. 10A and 10B illustrate the structure of a power storage unit 43, and a connecting portion 102 housing the power storage unit 43, included in an electronic device according to Embodiment 3. Other than a different structure for the power storage unit 43, this embodiment has the same structure as that of Embodiment 1. Accordingly, the following explanation focuses on the structure of the power storage unit 43.

FIG. 10A illustrates the structure of the power storage unit 43 included in the electronic device of this embodiment. The power storage unit 43 is a sheet battery formed in a sheet-like shape. The power storage unit 43 includes two electrodes 43b on one side, but the position of these electrodes may be selected freely. FIG. 10B illustrates a state in which the power storage unit 43 is wound and housed inside the connecting portion 102. Thus storing the wound power storage unit 43 inside the conductive portions 1a to 1d protects the power storage unit 43 from shock or the like.

Instead of winding the power storage unit 43 for placement inside the connecting portion 102, the power storage unit 43 may be folded and disposed inside the connecting portion 102.

As described above, according to this embodiment, the power storage unit 43 in which a sheet battery is wound or folded is disposed inside the connecting portion 102. As a result, the power storage unit 43 can be protected from shock or the like without using a highly rigid, tubular case as the container for the power storage unit 43, as in Embodiment 1. Therefore, the number of components can be reduced.

### Embodiment 4

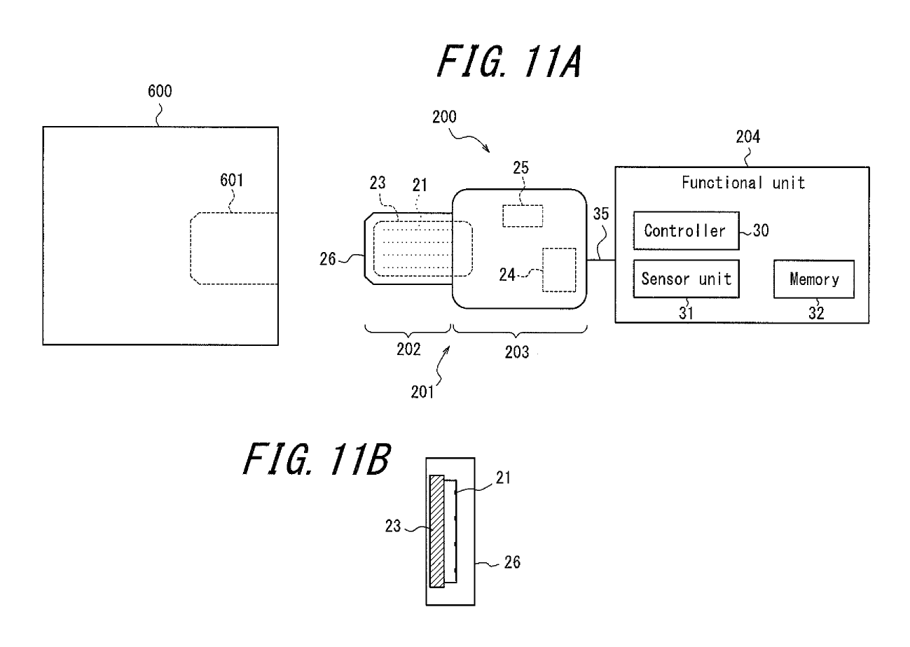

FIG. 11A illustrates the structure of an electronic device 200 according to Embodiment 4. The electronic device 200 of this embodiment includes a connector 201 for electrically connecting to another apparatus 600 and a functional unit 204 that controls the main functions of the electronic device 200, in which a sensor or the like is mounted. Other than a different structure for a connecting portion 202, the electronic device 200 has a similar structure to that of Embodiment 1. Accordingly, the following explanation focuses on the structure of the connecting portion 202.

The connecting portion 202 includes a power storage unit 23 and four conductive portions 21 inside a housing 26 formed from a conductive material. The connecting portion 202 may, for example, be a Universal Serial Bus (USB® (USB is a registered trademark in Japan, other countries, or both)) Type-A Plug. FIG. 11B illustrates the detailed structure of the connecting portion 202 as seen from the tip thereof. The four conductive portions 21 are disposed within the housing 26, which has a rectangular opening, at equal intervals in the longitudinal direction of the housing 26. In FIG. 11B, the power storage unit 23 is disposed to the left side of the conductive portions 21. In a typical USB Type-A Plug, a member insulating the housing 26 and the conductive portions 21 is disposed in the area in which the power storage unit 23 is disposed. By disposing the power storage unit 23 in this area in which an insulating member is disposed, an increase in the volume of the electronic device 200 can be reduced even while increasing the volume of the power storage unit 23. As in Embodiment 1, a configuration may be adopted in which only a portion of the power storage unit 23 is disposed inside the housing 26.

A USB receptacle 601 into which the connecting portion 202 is inserted is provided in another apparatus 600 to which the electronic device 200 connects. In this embodiment as well, the specifications of the connecting portion 202 may be modified in accordance with the interface of the other apparatus 600.

The connecting portion 202 (USB Type-A Plug) of this embodiment has four conductive portions 21, which are allocated as +5 V, data (+), data (−), and GND. Whereas +5 V is DC voltage, the data (+) and data (−) are AC signals with reverse polarity. Accordingly, when charging the power storage unit 23, charging may be performed in the same way as in Embodiment 1 by using the data (+) and data (−) of this embodiment instead of the L signal and R signal in Embodiment 1 and using the +5 V of this embodiment instead of the microphone signal. Note that data can be transmitted and received without use of an analog signal as in Embodiment 1. Instead, digital data can be transmitted and received directly between the electronic device 200 and the other apparatus 600.

As described above, when the conductive portion 21 is covered by a housing 26 with a relatively large volume, as in the connecting portion 202 (USB Type-A Plug) of this embodiment, a power storage unit 23 with a large volume can be housed inside the housing 26. With this structure, the increase in volume of the electronic device 200 can be reduced while including the power storage unit 23.

Although this disclosure is based on embodiments and drawings, it is to be noted that various changes and modifications will be apparent to those skilled in the art based on this disclosure. Therefore, such changes and modifications are to be understood as included within the scope of this disclosure. For example, the functions and the like included in the various components and steps may be reordered in any logically consistent way. Furthermore, components or steps may be combined into one or divided.

Much of the subject matter of this disclosure is described as a series of operations executed by a computer system that can execute program instructions and by other hardware. Examples of the computer system and other hardware include a general-purpose computer, a Personal Computer (PC), a dedicated computer, a workstation, a Personal Communications System (PCS), an RFID receiver, an electronic notepad, a laptop computer, a Global Positioning System (GPS) receiver, and other programmable data processing apparatuses. It should be noted that in each embodiment, a variety of operations are executed by a dedicated circuit (for example, individual logical gates interconnected in order to execute a particular function) implemented by program instructions (software), or by a logical block, program module, or the like executed by one or more processors. The one or more processors that execute a logical block, program module, or the like are, for example, one or more of each of the following: a microprocessor, a central processing unit (CPU), an Application Specific Integrated Circuit (ASIC), a Digital Signal Processor (DSP), a Programmable Logic Device (PLD), a Field Programmable Gate Array (FPGA), a processor, a controller, a microcontroller, an electronic device, another apparatus designed to be capable of executing the functions disclosed here, and/or a combination of any of the above. The embodiments disclosed here are, for example, implemented by hardware, software, firmware, middleware, microcode, or a combination of any of these. The instructions may be program code or a code segment for executing the necessary tasks. The instructions may be stored on a machine-readable, non-transitory storage medium or other medium. The code segment may indicate a combination of any of the following: procedures, functions, subprograms, programs, routines, subroutines, modules, software packages, classes or instructions, data structures, or program statements. The code segment may transmit and/or receive information, data arguments, variables, or memory content to or from another code segment or hardware circuit in order for the code segment to connect to another code segment or hardware circuit.

A network used here may, unless indicated otherwise, be the Internet, an ad hoc network, a Local Area Network (LAN), a cellular network, a Wireless Personal Area Network (WPAN), another network, or a combination of any of these. The constituent elements of a wireless network for example include an access point (such as a Wi-Fi access point), a femtocell, and the like. Furthermore, a wireless communication device can connect to a wireless network that uses Wi-Fi, Bluetooth® (Bluetooth is a registered trademark in Japan, other countries, or both)), cellular communication technology (such as Code Division Multiple Access (CDMA), Time Division Multiple Access (TDMA), Frequency Division Multiple Access (FDMA), Orthogonal Frequency Division Multiple Access (OFDMA), or Single-Carrier Frequency Division Multiple Access (SC-FDMA)), or other wireless technology and/or technical standards.

The machine-readable, non-transitory storage medium used here may also be configured by a computer-readable, tangible carrier (medium) in the categories of solid-state memory, magnetic disks, and optical discs. Data structures and an appropriate set of computer instructions, such as program modules, for causing a processor to execute the techniques disclosed here are stored on these media. Examples of computer-readable media include an electrical connection with one or more wires, a magnetic disk storage medium, a magnetic cassette, a magnetic tape, or other magnetic or optical storage medium (such as a Compact Disc (CD), laser disc®, Digital Versatile Disc (DVD®), floppy® disk, and Blu-ray disc® (laser disc, DVD, floppy, and Blu-ray disc are each a registered trademark in Japan, other countries, or both)), portable computer disk, random access memory (RAM), read-only memory (ROM), rewritable programmable ROM such as EPROM, EEPROM, or flash memory, another tangible storage medium that can store information, or a combination of any of these. The memory may be provided internal and/or external to a processor/processing unit. As used in this disclosure, the term “memory” refers to all types of long-term storage, short-term storage, volatile, non-volatile, or other memory. No limitation is placed on the particular type or number of memories, or on the type of medium for memory storage.

While the disclosed system has a variety of modules and/or units for implementing particular functions, these modules and units have only been indicated schematically in order to briefly illustrate the functionality thereof. It should be noted that no particular hardware and/or software is necessarily indicated. In this sense, it suffices for the modules, units, and other constituent elements to be hardware and/or software implemented so as to substantially execute the particular functions described here. The various functions or different constituent elements may be combined with or separated from hardware and/or software in any way, and each may be used individually or in some combination. An input/output (I/O) device or user interface including, but not limited to, a keyboard, display, touchscreen, pointing device, or the like may be connected to the system directly or via an I/O controller. In this way, the various subject matter disclosed herein may be embodied in a variety of forms, and all such embodiments are included in the scope of the subject matter in this disclosure.

1. A connector comprising:
a connecting portion configured to connect electrically to another apparatus; and
a power storage unit, wherein
at least a portion of the power storage unit is disposed inside the connecting portion.

2. The connector of claim 1, wherein the power storage unit is charged by power supplied from the other apparatus via the connecting portion.

3. The connector of claim 1, wherein the connecting portion includes a housing configured to connect electrically to the other apparatus.

4. The connector of claim 3, wherein
the housing includes a plurality of conductive portions each configured to connect electrically to the other apparatus, and
the plurality of conductive portions are joined together with an insulating member therebetween.

5. The connector of claim 3, wherein the housing houses the power storage unit therein and is sealed.

6. The connector of claim 1, wherein the power storage unit comprises at least:
a laminated sheet having laminated and wound therein a positive electrode, a negative electrode, and a separator layer between the positive electrode and the negative electrode;
an electrolyte, the laminated sheet being impregnated with the electrolyte; and
an insulating packaging member covering the laminated sheet and the electrolyte.

7. The connector of claim 1, wherein the power storage unit is a sheet-like battery that is wound or folded.

8. The connector of claim 5, wherein the power storage unit is charged by power supplied from the other apparatus via the connecting portion.

9. The connector of claim 5, wherein
the housing includes a plurality of conductive portions each configured to connect electrically to the other apparatus, and
the plurality of conductive portions are joined together with an insulating member therebetween.

10. The connector of claim 5, wherein the power storage unit comprises at least:
a laminated sheet having laminated and wound therein a positive electrode, a negative electrode, and a separator layer between the positive electrode and the negative electrode;
an electrolyte, the laminated sheet being impregnated with the electrolyte; and
an insulating packaging member covering the laminated sheet and the electrolyte.

11. An electronic device comprising:
a functional unit;
a power storage unit configured to supply power to the functional unit; and
a connector including a connecting portion, the connector configured to connect electrically to another apparatus via the connecting portion, wherein
at least a portion of the power storage unit is disposed inside the connector.

12. The electronic device of claim 11, wherein at least a portion of the power storage unit is disposed inside the connecting portion.

13. The electronic device of claim 11, wherein the power storage unit is charged by power supplied from the other apparatus via the connecting portion.

14. The electronic device of claim 13, further comprising:
a charging controller configured to control charging of the power storage unit, wherein
the charging controller controls charging of the power storage unit upon the connector being connected electrically to the other apparatus.

15. The electronic device of claim 11, wherein
the functional unit
is supplied power by at least one of the other apparatus and the power storage unit upon the connector being connected electrically to the other apparatus, and
is supplied power by the power storage unit upon the connector being electrically disconnected from the other apparatus.

16. The electronic device of claim 11, wherein the functional unit comprises a sensor and a memory, the memory stores sensor information detected by the sensor, and upon the connector being connected electrically to the other apparatus, the sensor information stored in the memory is transmitted to the other apparatus via the connecting portion.

17. The electronic device of claim 12, wherein the power storage unit is charged by power supplied from the other apparatus via the connecting portion.

18. The electronic device of claim 14, wherein at least a portion of the power storage unit is disposed inside the connecting portion.

19. The electronic device of claim 12, wherein
the functional unit
is supplied power by at least one of the other apparatus and the power storage unit upon the connector being connected electrically to the other apparatus, and
is supplied power by the power storage unit upon the connector being electrically disconnected from the other apparatus.

20. The electronic device of claim 12, wherein the functional unit comprises a sensor and a memory, the memory stores sensor information detected by the sensor, and upon the connector being connected electrically to the other apparatus, the sensor information stored in the memory is transmitted to the other apparatus via the connecting portion.
